(19) United States
(12) Patent Application Publication
(10) Pub. No.: US 2022/0277381 A1
(43) Pub. Date: Sep. 1, 2022

(54) Interface for Matching a Racquet Sports Player and a Racquet Stringer

(71) Applicant: MASTER STRINGERS, Mareil-Marly (FR)

(72) Inventor: Jean-Mathieu MENNEGLIER, Mareil-Marly (FR)

(21) Appl. No.: 17/631,467

(22) PCT Filed: Jul. 30, 2020
(86) PCT No.: PCT/EP2020/071496

§ 371 Date: Jan. 29, 2022

(30) Foreign Application Priority Data
Jul. 30, 2019 (FR) FR1908667

(51) Int. Cl. G06Q 30/06

(52) U.S. Cl. CPC G06Q 30/0639; G06Q 30/0641; G06Q 30/0613; G06Q 30/0625; H04L 51/04

(57) ABSTRACT

Linking interface (INT) between a racket sports player (J) and at least one stringer from a list of stringers (C1, . . . , Cn) registered in a database (BD), characterized in that it comprises a human-machine input interface (1) configured to allow the player (J) to enter a stringer selection criterion, acquisition means (2) configured to remotely acquire the list of registered stringers (C1, . . . Cn), calculation means (3) configured to filter the stringers according to said at least one criterion, geolocation means (4) configured to geolocate the player (J) and selection means (5) configured to select one or more stringers based on the geolocation result.

The present invention relates to mobile applications and relates more particularly to connection interfaces for linking two operators.

A mobile application, that is to say adapted to the mobile format, is software that can be downloaded and run on so-called “smart” phones or “smartphone” in English, or any other electronic device that can run source code.

Generally, a mobile application requires an internet connection to function. Mention may be made, for example, of an application relating to a social network or a browser. Some can work independently, such as a calculator.

With the evolution of digital tools, mobile applications are now an integral part of professional and daily practices.

For example, in the world of racket sports, digital tools, such as websites, provide access to the contact details of professionals or order equipment without having to travel.

However, for a player to succeed in finding the professional(s) closest to his position, he is forced to compare by himself the various addresses offered within a delimited perimeter and determine the closest professional, which may be long and tedious.

In addition, certain professions such as stringer are generally not referenced. There is currently no automated interface for linking a professional type stringer and a racket sports player.

There are multiple challenges, such as reducing the search time for a stringer by means of an automated linking device that adapts to the player's criteria and which makes it possible to offer one or more stringers close to the player's position and corresponding to his expectations.

In view of the foregoing, the subject of the invention is a method for linking a racket sports player and at least one stringer from a list of stringers registered in a database, in which the player enters by means of from a man-machine interface at least one stringer selection criterion, the list of registered stringers is retrieved remotely, calculation means are implemented to filter the stringers according to said at least one criterion, the player is geolocated and one or more stringers are selected according to the result of the geolocation.

By “stringer” is meant any professional with mastery of skills in the various laying techniques and knowledge of the technical characteristics of strings.

The database includes a list of registered stringers which can be updated manually or automatically. It is hosted on a server which makes it possible to authorize the consultation of the list of stringers by several players simultaneously or successively.

To access the database, the player must enter using, for example, a numeric keypad at least one selection criterion. Once entered, said at least one criterion is sent from the entry interface to calculation means, for example a microprocessor, which also retrieve the list of stringers from the database by requesting access to the server.

Following this, the calculation means check whether the stringers satisfy said at least one selection criterion and then propose a filtered list of stringers.

Then, the distance between the stringer and the player is calculated after acquisition of the data making it possible to geolocate the player in real time and a list of stringers geographically closest to the player and which correspond to said at least one criterion is delivered.

It should be noted that the geolocation of the player can be carried out by a GPS receiver and by a satellite positioning system or any other means making it possible to position the player on a map using his geographic coordinates.

Of course, stringers can also choose to be in active or inactive mode, therefore geolocated in real time if they do not have a fixed position or move regularly.

Advantageously, said at least one selection criterion comprises a limitation of the search scope of the stringer and/or a limitation of the cost of labor proposed by the stringer and/or a limitation of the cost of at least one product sale by the stringer and/or the time for completion of a service requested by the player and/or the relay points available for the withdrawal of the product that the player wishes to buy or the withdrawal of the product resulting from the service requested and/or the technique laying the string of a racket.

Said at least one product offered for sale by the stringer can be compared with other offers on the market via metasearch engines for example or if the player prefers it, he can first do a search via metasearch engines to get an idea of the price before entering the selection criterion relating to the limitation of the cost of said at least one product offered for sale by the stringer.

We can also compare so-called intangible services based on non-quantifiable criteria such as user experience or a stringer's rating.

The string laying technique can include, for example, a selection of different laying methods and standard or custom knot types. For example, we can propose a laying technique in 2 or 4 knots and/or in 50-50 and/or according to the ATW technique and/or according to an alternating technique, that is to say, a rope on each side.

Preferably, the service requested by the player includes the production and/or personalization of at least one element of a racket by digital printing.

By “element of a racket” is meant, for example, a stencil or a racket handle, and by “digital printing” any process for manufacturing parts in volume by adding or agglomeration of material such as 3D or 4D printing.

The player can thus choose among his selection criteria that an element be manufactured using this process.

Thus, a racquet can be partially or totally customized according to the preferences of the player.

For example, said at least one element can be a stencil. The player can for example select a model or create and personalize it by adding numbers and/or his initials and/or a logo or smiley type design.

Said at least one element can also be the handle. The player can thus choose the shape and thickness of the handle.

The goal of personalization may be a constant search for performance optimization according to the player's profile.

Preferably, the method comprises a transmission of the messages sent between the player and said at least one proposed stringer, in real time or delayed.

The exchange of messages can be done for example via a social network offline if the player or the stringer is not connected to an Internet network or in real time if the stringer and the player are connected at the same time.

Alternatively, the player may choose to complete a contact form.

According to another aspect, there is proposed an interface for linking a racket sports player and at least one stringer from a list of stringers registered in a database, comprising a human-machine input interface configured to allow the input to the player of a stringer selection criterion, acquisition means configured to acquire the list of registered stringers, calculation means configured to filter the stringers according to said at least one criterion, geolocation means configured to geolocate the player and selection means configured to select one or more stringers according to the result of the geolocation.

Advantageously, said at least one selection criterion comprises a limitation of the search scope of the stringer and/or a limitation of the cost of labor proposed by the stringer and/or a limitation of the cost of at least one product sale by the stringer and/or the time for completion of a service requested by the player and/or the relay points available for the withdrawal of the product that the player wishes to buy or the withdrawal of the product resulting from the service requested and/or the technique laying the string of a racket.

Preferably, the service requested by the player includes the production of at least one element of a racket by digital printing.

Preferably, the interface comprises online communication means capable of transmitting the messages sent between the player and said at least one proposed stringer, in real time or delayed.

The invention also relates to a mobile application comprising a linking interface as defined above.

Mobile application means any downloadable digital tool capable of being executed on a device such as a smart phone or “smartphone” or tablet.

Other advantages and characteristics of the invention will appear on examination of the detailed description of the modes of implementation and embodiment of the invention, which are in no way limiting, and of the appended drawings in which:

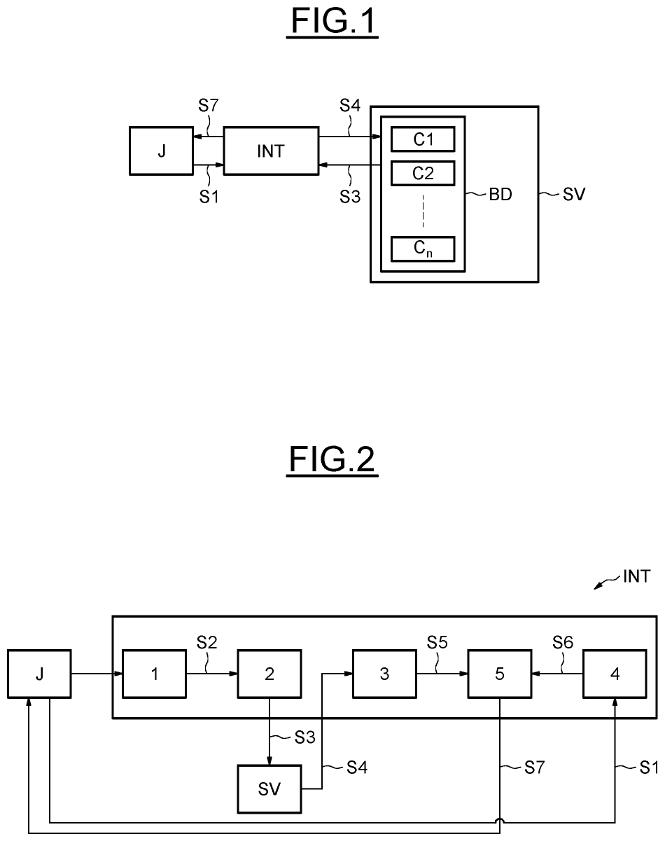

FIG. 1 schematically represents an example of a connection between a racket sports player and at least one stringer according to one mode of implementation of the invention;

FIG. 2 illustrates a connection interface between the player and said at least one stringer according to one embodiment of the invention.

FIG. 1 represents an example of a connection between a racket sports player and at least one stringer from a list of stringers C1 to Cn where n represents the number of stringers registered in a database BD whose access is authorized by a server SV hosting said database BD.

In this example, player J wishes to call on a stringer, preferably as close as possible to his current position and corresponding to his selection criteria.

For this, the player J enters data representing at least one selection criterion proposed by the interface.

We can cite as a selection criterion a geographical restriction of the search space, for example to a radius of 20 km from the current position of player J.

We can also add a limitation of the cost of labor proposed by the stringer, a limitation of the cost of a product offered for sale or of several products if player J wishes to make a group purchase.

A delay in performing the service requested by player J can also be a selection criterion. As a service, player J can request that an element of a racket prototype offered for sale be produced in 3D or 4D digital printing. He can thus also choose as a criterion a deadline for the withdrawal of his purchase.

Player J can just as well request that an element of his racket be replaced by another made using digital printing. For this, player J also has the possibility of choosing as a selection criterion a deadline for depositing his racket to transport it to the address of the nearest stringer.

Whether it is to deposit or withdraw a product, player J can also choose relay points for depositing or withdrawing a product and furthermore restrict the scope of the relay points available.

Once the selection criteria has been entered, the INT interface retrieves the GPS coordinates of player J1 via a transmission channel S1.

It should be noted that a communication channel recovers the data to be transmitted by a buffer memory capable of storing said data before transmission.

Of course, buffer memory, commonly referred to as a “buffer”, is any area of RAM used to temporarily store data.

The interface INT then requests remote access from the server SV to the list of stringers C1 to Cn via a transmission channel S3. Once access has been granted by the server SV, the interface INT retrieves via a transmission channel S4, the list of stringers C1 to Cn.

To retrieve data remotely, the INT interface includes any electronic means for transmitting data remotely, for example via a satellite connection.

The interface INT is then able to filter the list C1 to Cn according to said at least one criterion, select one or more stringers according to the result of the geolocation and display the selected stringers on the display screen of the player J sent via an S7 transmission channel.

The INT interface is thus configured to use the data retrieved by the various transmission channels in order to filter the stringers according to said at least one selection criterion and to select one or more stringers according to the result of the geolocation.

As illustrated in FIG. 2, the INT interface includes several software or hardware modules if the function provided by said module allows it.

The interface INT here comprises an input man-machine interface 1 configured to allow input to the player J for example via a numeric keypad of a mobile phone.

The input man-machine interface 1 is coupled to acquisition means 2 capable of remotely acquiring the list of registered stringers C1 to Cn.

The acquisition means 2 are virtually coupled to the server SV itself coupled to calculation means 3 by the transmission channel S4.

The calculation means 3 are configured to filter the stringers according to said at least one entered criterion.

The INT interface also comprises geolocation means 4, in particular a GPS receiver allowing transmission of the position of the player J in real time via the communication channel S1 of the GSM type (for “Global System for Mobile Communications” in English) or LTE (“Long Term Evolution” according to the Anglo-Saxon term).

The geolocation means 4 are coupled to selection means 5 configured to receive the filtered list of stringers via a communication channel S5 according to said at least one criterion entered and the position of the player J via a communication channel S6.

Once this data has been received, the selection means 5 select one or more stringers according to the result of the real-time geolocation of the player J.

The list of selected stringer(s) is transmitted to the player via the S7 transmission channel and is displayed, for example, on the screen of player J's mobile phone.

Player J can thus enter into communication with the selected stringer(s) and exchange messages remotely through a social network.

The stringers selected are thus stringers having the smallest geographical proximity while satisfying said at least one selection criterion.

Furthermore, the invention is not limited to these embodiments and implementations but encompasses all variants thereof, for example, the interface may include other selection criteria, the number of which may be unlimited. In this case, the calculation means 3 can include a deep learning module configured to take into account and analyze new criteria.

1. A method for linking a racket sports player and at least one stringer from a list of stringers registered in a database, wherein the player enters by means of a man-machine interface at least one stringer selection criterion, the list of registered stringers is retrieved remotely, calculation means are implemented to filter the stringers according to the at least one criterion, the player is geolocated, and one or more stringers are selected according to the result of the geolocation and the at least one criterion.

2. The method according to claim 1, wherein the at least one selection criterion comprises a limitation of the search perimeter of the stringer and/or a limitation of the cost of the labor proposed by the stringer and/or a limitation of the cost of at least one product put up for sale by the stringer and/or the time for completion of a service requested by the player and/or relay points available for the withdrawal of the product that the player wishes to buy or withdrawal of the resulting product of the service requested and/or the technique for laying the string of a racquet.

3. The method according to claim 2, in which the service requested by the player comprises the production of at least one element of a racket by digital printing.

4. The method according to any one of the preceding claims, further comprising transmitting messages sent between the player and said at least one proposed stringer, in real time or delayed.

5. A linking interface between a racket sports player and at least one stringer from a list of stringers registered in a database, comprising:
an input man-machine interface configured to allow the player to input a stringer selection criterion;
acquisition means configured to remotely acquire the list of stringers registered;
calculation means configured to filter the stringers according to said at least one criterion;
geolocation means configured to geolocate the player; and
selection means configured to select one or more stringers based on the geolocation result.

6. The linking interface according to claim 5, wherein the at least one selection criterion comprises a limitation of the search scope of the stringer and/or a limitation of the cost of the labor proposed by the stringer and/or a limitation of the cost of at least one product put up for sale by the stringer and/or the time for completion of a service requested by the player and/or the relay points available for the withdrawal of the product that the player wishes to buy or the withdrawal of the resulting product of the service requested and/or the technique for laying the string of a racquet.

7. The linking interface according to claim 6, wherein the service requested by the player comprises the production and personalization of at least one element of a racket by digital printing.

8. The linking interface according to any one of claims 5 to 7, further comprising an online communication means capable of transmitting messages sent between the player and said at least one proposed stringer, in real time or delayed.

9. A mobile application comprising the linking interface according to any one of claims 5 to 8.
